(19) United States
(12) Patent Application Publication
(10) Pub. No.: US 2009/0046730 A1
(43) Pub. Date: Feb. 19, 2009

(54) Network switching apparatus for redundancy gateway system

(75) Inventors: Takeshi Shimomura, Saitama (JP); Yuzuru Masuya, Kanagawa (JP); Koichi Kihara, Chiba (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/213,577

(22) Filed: Jun. 20, 2008

(30) Foreign Application Priority Data
Aug. 17, 2007 (JP) 2007-212858

(51) Int. Cl. H04L 12/66

(52) U.S. Cl. 370/401

(57) ABSTRACT

A network switching apparatus which is provided between a redundancy gateway system and a packet network and enables an uninterruptible changeover in a system changeover to be performed. The apparatus includes an up-direction transfer unit and a down-direction transfer unit. The down-direction transfer unit receives a changeover notification packet accompanied with designation information of a new active system gateway apparatus which has newly been set in place of an active system gateway apparatus. After the reception of the changeover notification packet, only in the case where a down-direction packet which is newly transmitted by the packet network is accompanied with designation information of the active system gateway apparatus before the changeover, the down-direction transfer unit changes the designation information to the designation information of the new active system gateway apparatus, thereby transferring the down-direction packet to the new active system gateway apparatus.

### BACKGROUND OF THE INVENTION

1. Field of the Invention

The invention relates to a network switching apparatus for transferring a packet between a packet network and a redundancy gateway system which includes a plurality of gateway apparatuses constituting a multiple-redundant structure.

2. Description of the Related Arts

Generally, gateway apparatuses for mutually connecting a packet network and a telephone network and relaying a packet carrying audio information are often constructed as a redundancy gateway system. Such a redundancy gateway system includes in its structure gateway apparatuses that are provided in duplex or more redundancy in order to suppress the burden on users when a failure occurs. For example, in a duplex-redundancy construction one of the two gateway apparatuses is provided as an active system (hereinafter, referred to as ACT system) and the other is provided as a standby system (hereinafter, referred to as SBY system). In such a construction, when a failure occurs in the active system or when a maintenance work of the active system is necessary, a system changeover is performed between the active system and the standby system. A technique for preventing the occurrence of an interruption of communication at the time of the system changeover has been devised and disclosed in Japanese Patent Kokai No. 2005-57461 (Patent Document 1).

To perform the system changeover of the redundancy gateway system, it is necessary to transfer the packet to all of a plurality of gateway apparatuses. In the case where a packet network itself is not constructed as a redundant system, means using a packet duplicating function may be provided in a network switching apparatus in order to transfer the packet to all of the plurality of gateway systems.

As a function for such a network switching apparatus, for example, a function is known in which the packets of the same contents are transferred to a plurality of apparatuses through a plurality of ports by performing the mirroring of the packet. This function is described in Section 14.2.1 of “The Switch Book: Complete Guide to LAN Switching Technology” written by Rich Seifert, published by John Wiley and Sons Inc. (Non-Patent Document 1).

### OBJECTS AND SUMMARY OF THE INVENTION

The technique disclosed in the Non-Patent Document 1, however, has been devised for an incidental operation including, for example, a network monitoring apparatus or the like. In the actual operation for the redundancy gateway system as a prerequisite, a difficult problem occurs in association with a relation between an IP (Internet Protocol) address for logically identifying each apparatus such as a gateway apparatus or router on the network and an MAC (Media Access Control) address for physically identifying each apparatus on the network.

System of the IP address and the MAC address of the redundancy gateway system will now be described. It is ordinary to use a construction in which the IP addresses of the gateway apparatuses of two systems have the same IP address value while the MAC addresses of the two systems have the different MAC address values. In this type of construction, since the IP addresses of the two systems are identical, an advantage is that even if the ACT system and the SBY system of the reception side are switched, on the transmission side, it is sufficient to always transmit the packet to the same IP address without being conscious of the system changeover.

Even if the system changeover occurs in the redundancy gateway system due to a failure or a scheduled operation, since the IP address of each system is identical the transmission side continues to transmit the packet to the redundancy gateway system without being conscious of the system changeover. However, in a LAN network which physically connects the router, LAN switching apparatus, gateway apparatuses, and the like, since the packet is transferred according to the MAC addresses, it is necessary to change an ARP (Address Resolution Protocol) table which is stored in each node such as a LAN switching apparatus or a gateway apparatus and enables the IP address and the MAC address to be exchanged, at the time of the system changeover. Therefore, it is conceivable to devise a method of using a GARP (Gratuitous ARP) in order to forcedly change the ARP table.

That is, the gateway apparatus which has become the new ACT system at the time of the system changeover transmits a message of the GARP to each node, and updating of the ARP table of each node is tried. However, for a transient period of time until the updating is complete, the packet is transmitted by using the MAC address of the old ACT system as a destination and all of the packets for the period of time are transferred to the old ACT system. For the transient time during which the system changeover is executed, therefore, the packet is transferred to the old ACT system without being transferred to the new ACT system to cause a packet loss, resulting in a problem that a hitless switching cannot be accomplished.

The invention has been made in view of the foregoing problems and it is an object of the invention is to provide a network switching apparatus which exists between a redundancy gateway system and a packet network and which enables a hitless switching at the time of a system changeover.

According to a first aspect of the invention, there is provided a network switching apparatus which is provided between a packet system and a plurality of gateway apparatuses at least one of which is provided as a gateway apparatus of an active system, which comprises: an up-direction transfer unit which transfers an up-direction packet which is transmitted by the active system gateway apparatus to the packet network; and a down-direction transfer unit which transfers a down-direction packet which is accompanied with designation information of the active system gateway apparatus and transmitted by the packet network in accordance with the up-direction packet to the active system gateway apparatus, wherein the down-direction transfer unit includes a changeover notification packet receiving component which receives a changeover notification packet accompanied with designation information of a new active system gateway apparatus which has newly been set in place of the active system gateway apparatus and a switching-time transfer component which changes the designation information to the designation information of the new active system gateway apparatus, thereby transferring the down-direction packet to the new active system gateway apparatus, only in the case where a down-direction packet which is newly transmitted by the packet network after the reception of the changeover notification packet is accompanied with the designation information of the active system gateway apparatus before the changeover.

According to a second aspect of the invention, there is provided a network switching apparatus which is provided between a packet network and a plurality of gateway apparatuses at least one of which is provided as a gateway apparatus of an active system, which comprises: an up-direction transfer unit which transfers an up-direction packet which is transmitted by the active system gateway apparatus to the packet network; and a down-direction transfer unit which transfers a down-direction packet which is accompanied with designation information of the active system gateway apparatus and transmitted by the packet network in accordance with the up-direction packet to the active system gateway apparatus, wherein the down-direction transfer unit includes a standby system gateway apparatus discriminating component which discriminates the gateway apparatus, as a standby system gateway apparatus, other than the active system gateway apparatus corresponding to the designation information accompanied with the down-direction packet every down-direction packet which is newly transmitted by the packet network and a replication packet transfer component which forms a replication packet of the down-direction packet every discriminated standby system gateway apparatus and changes designation information accompanied with the replication packet to designation information of the standby system gateway apparatus, thereby transferring the replication packet to the standby system gateway apparatus.

By the network switching apparatus of the invention, which is arranged between the redundancy gateway system and the packet network, it has become possible to perform the hitless switching upon system changeover.

### BRIEF DESCRIPTION OF THE DRAWINGS

FIG. 1 shows the first embodiment and is a block diagram showing a whole construction including a LAN switching apparatus according to the invention;

FIG. 2 is a block diagram showing an internal construction of the LAN switching apparatus;

FIG. 3 is a flowchart showing a processing procedure of the LAN switching apparatus at the time of a system changeover;

FIG. 4A is a block diagram showing a flow of a packet at the time of the system changeover in the first embodiment;

FIG. 4B is a block diagram further showing the flow of the packet at the time of the system changeover in the first embodiment;

FIG. 5 shows a modified form of the first embodiment and is a block diagram showing a whole construction including the LAN switching apparatuses according to the invention;

FIG. 6A is a block diagram showing a flow of a packet at the time of the system changeover in the modified form;

FIG. 6B is a block diagram further showing the flow of the packet at the time of the system changeover in the modified form;

FIG. 7 shows the second embodiment and is a flowchart showing a processing procedure in a down-direction of a LAN switching apparatus; and

FIG. 8 is a block diagram showing a flow of a packet at the time of a system changeover in the second embodiment.

### DETAILED DESCRIPTION OF THE PREFERRED EMBODIMENTS

Embodiments of the invention will now be described in detail with reference to the drawings.

### First Embodiment

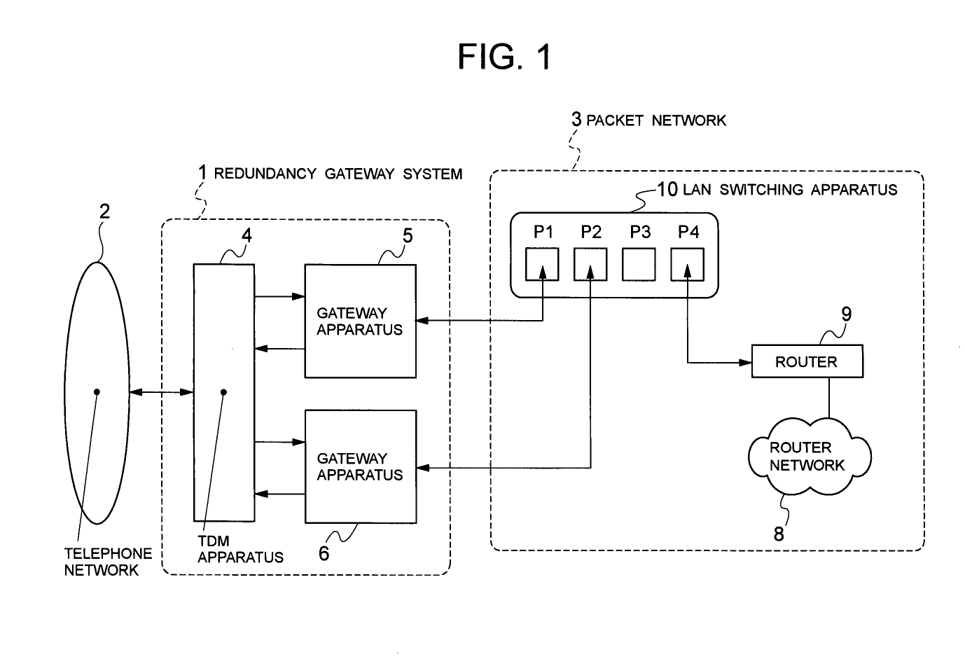

FIG. 1 shows the first embodiment and shows a whole construction including a LAN switching apparatus according to the invention. A redundancy gateway system 1 is connected between a telephone network 2 and a packet network 3 including a LAN switching apparatus 10 corresponding to a network switching apparatus according to the invention. The redundancy gateway system 1 is arranged between the packet network 3 as a packet network and the telephone network 2 as a TDM network. The redundancy gateway system 1 includes: at least two gateway apparatuses 5 and 6 which form a plural system and are multiple-constructed; and a TDM apparatus 4.

The TDM apparatus 4 has a function of selectively switching the gateway apparatuses 5 and 6 to either the active system or the standby system in accordance with a system changeover request based on a failure or a schedule operation and relaying a TDM signal between at least the gateway apparatus which has been set to the active system and the telephone network 2. In the specification, the gateway apparatus of the active system between the gateway apparatuses 5 and 6 is called a gateway apparatus of the “ACT system”, the gateway apparatus of the standby system is called a gateway apparatus of the “SBY system”, and an explanation will be made below.

The gateway apparatuses 5 and 6 have the same internal construction and form a redundant construction in which they can be mutually alternated. Each of the gateway apparatuses 5 and 6 receives the packet supplied from the packet network 3 while properly executing a jitter corresponding process, converts audio data conveyed by the received packet into the TDM signal, and transmits the converted TDM signal to the telephone network 2 through the TDM apparatus 4. Each of the gateway apparatuses 5 and 6 also has a function of receiving the TDM signal supplied from the telephone network 2 through the TDM apparatus 4, executing a conversion for packetizing the audio data conveyed by the received TDM signal, and transmitting the obtained packet toward the packet network 3.

It is assumed that the redundancy gateway system 1 including the gateway apparatuses 5 and 6 has the following four functions in order to cope with the LAN switching apparatus 10 according to the invention.

First, the redundancy gateway system 1 has the function of transmitting a changeover notification packet for notifying the LAN switching apparatus 10 serving as an upper apparatus that the system changeover occurs when switching between the ACT system and the SBY system. Second, the redundancy gateway system 1 has the function of receiving a changeover reception packet to notify a fact that a process corresponding to the changeover notification packet has been completed in the upper apparatus from the LAN switching apparatus 10 as an upper apparatus. Third, the redundancy gateway system 1 has the function of stopping the transmitting process for a period of time until the changeover reception packet is received after the transmission of the changeover notification packet although the receiving process is executed with respect to the packet in which the audio data and the like exist. Fourth, the redundancy gateway system 1 has the function of executing the system changeover between the ACT system and the SBY system with respect to the gateway apparatuses 5 and 6 for the first time after the reception of the changeover reception packet. Each of the four functions can be easily realized by software or hardware of the redundancy gateway system 1.

The packet network 3 is constructed by a router network 8, a router 9, and the LAN switching apparatus 10. The LAN switching apparatus 10 has four ports P1 to P4, is connected to the gateway apparatus 5 through the port P1, is connected to the gateway apparatus 6 through the port P2, and is connected to the router 9 through the port P4, respectively. The router 9 is connected to the router network 8. Although the construction in which the number of ports of the LAN switching apparatus 10 is equal to 4 has been illustrated in the diagram, the invention is not limited to 4 but an arbitrary number of ports can be selected so long as the ports can be provided.

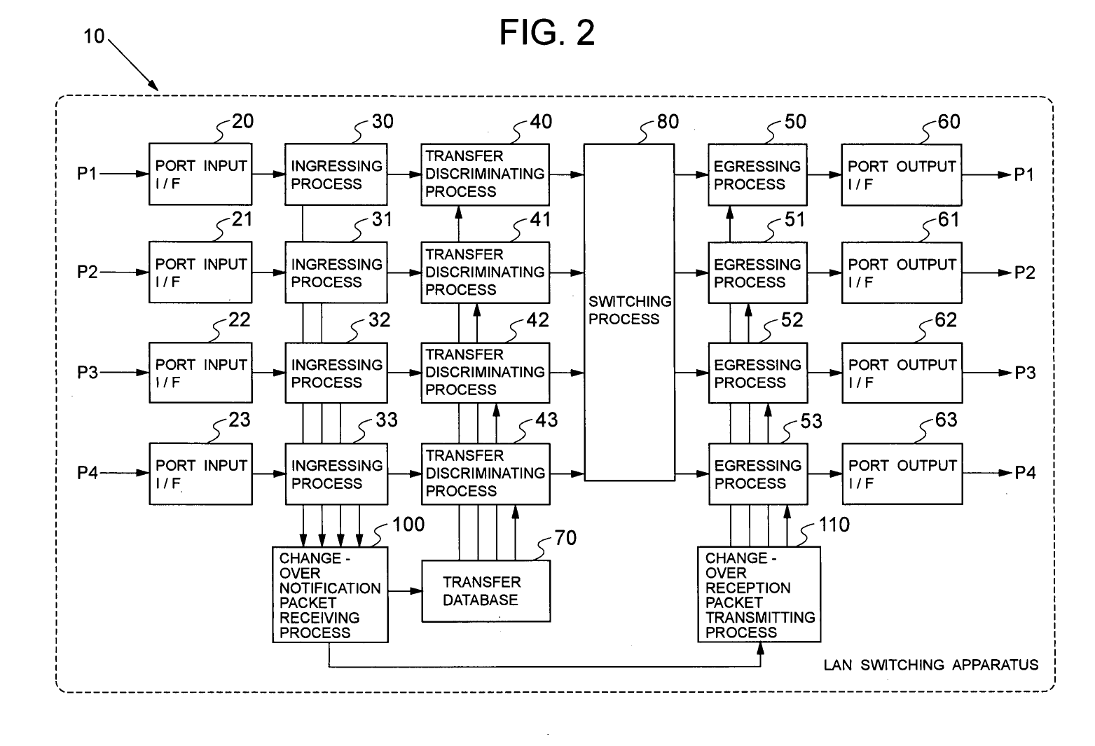

FIG. 2 shows an internal construction of the LAN switching apparatus 10. Each of port input interfaces 20 to 23 receives an input signal of the packet through a corresponding one of the ports P1 to P4, adjusts a signal level, and thereafter, transfers the packet to a corresponding one of ingressing processes 30 to 33. In each of the ingressing processes 30 to 33, packet input processes such as process for discriminating whether or not the packet is received, filtering process, and FCS (Frame Check Sequence) process are executed to the transferred packet. The ordinary packets are transferred to transfer discriminating processes 40 to 43. The changeover notification packet from the redundancy gateway system is transferred to a changeover notification packet receiving process 100.

Each of the transfer discriminating processes 40 to 43 is a portion for discriminating from which port the input packet is sent, reallocating the MAC address, and executing a forming process of the replication packet. Each of the transfer discriminating processes 40 to 43 asks for an instruction from a transfer database 70 every packet, discriminates a transfer destination, and transfers the packet to a switching process 80. The switching process 80 switches the transferred packets, that is, transfers the switched packet to one of egressing processes 50 to 53 corresponding to the transfer destination determined by the transfer discriminating processes 40 to 43.

Each of the egressing processes 50 to 53 executes packet output processes such as tag process, filtering process, and FCS calculation to the transferred packet and transfers the processed packet to a corresponding one of port output interfaces 60 to 63. Each of the egressing processes 50 to 53 also receives a packet serving as a changeover reception packet from a changeover reception packet transmitting process 110. Each of the port output interfaces 60 to 63 executes a process for transmitting the transferred packet and transmits the packet through a corresponding one of the ports P1 to P4.

The transfer database 70 is a database in which the MAC addresses and port numbers of the gateway apparatuses 5 and 6 are previously registered and state information of the ACT system/SBY system is updated in accordance with the reception of the system changeover packet which is performed by the changeover notification packet receiving process 100. The transfer database 70 decides the transfer destination of the packet in response to an instructing request from each of the transfer discriminating processes 40 to 43 and notifies a corresponding one of the transfer discriminating processes 40 to 43 of its result.

The changeover notification packet receiving process 100 receives the changeover notification packet from the redundancy gateway system and notifies the transfer database 70 of its result, thereby issuing an instruction for reallocating the destination MAC addresses. The changeover notification packet which is transmitted from the gateway apparatus 5 or 6 is a packet in which the LAN switching apparatus 10 is set to the destination and a packet format using an SNMP (Simple Network Management Protocol) as a base is used. Since it is sufficient that the changeover notification packet can be received by the LAN switching apparatus 10, the packet format is not limited to the SNMP base and any other packet format may be used so long as it can recognize the LAN switching apparatus 10. The changeover notification packet receiving process 100 is connected to the changeover reception packet transmitting process 110.

The changeover reception packet transmitting process 110 receives the result from the changeover notification packet receiving process, executes the process for transmitting the changeover reception packet, and notifies the egressing processes 50 to 53 of the result, so that the changeover reception packet is transmitted to the outside through one of the ports P1 to P4 in a manner similar to the ordinary packet. The changeover reception packet is a packet in which the gateway apparatus 5 or 6 is set to the destination and the packet format using the SNMP base is used. Since it is sufficient that the changeover reception packet can be received by the gateway apparatus 5 or 6, the packet format is not limited to the SNMP base and any other packet format may be used so long as it can recognize the gateway apparatus 5 or 6.

As mentioned above, the LAN switching apparatus 10 corresponds to the network switching apparatus according to the invention. In the internal construction of the LAN switching apparatus 10 shown in FIG. 2, for example, for the gateway apparatus 5, an up-direction transfer unit as a component element of the invention is constructed by component portions on a path starting from the port P1 on the left side in the drawing and reaching the port P4 on the right side in the drawing and a down-direction transfer unit is constructed by component portions on a path starting from the port P4 on the left side in the drawing and reaching the port P1 on the right side in the drawing. For the gateway apparatus 6, an up-direction transfer unit as a component element of the invention is constructed by component portions on a path starting from the port P2 on the left side in the drawing and reaching the port P4 on the right side in the drawing and a down-direction transfer unit is constructed by component portions on a path starting from the port P4 on the left side in the drawing and reaching the port P2 on the right side in the drawing.

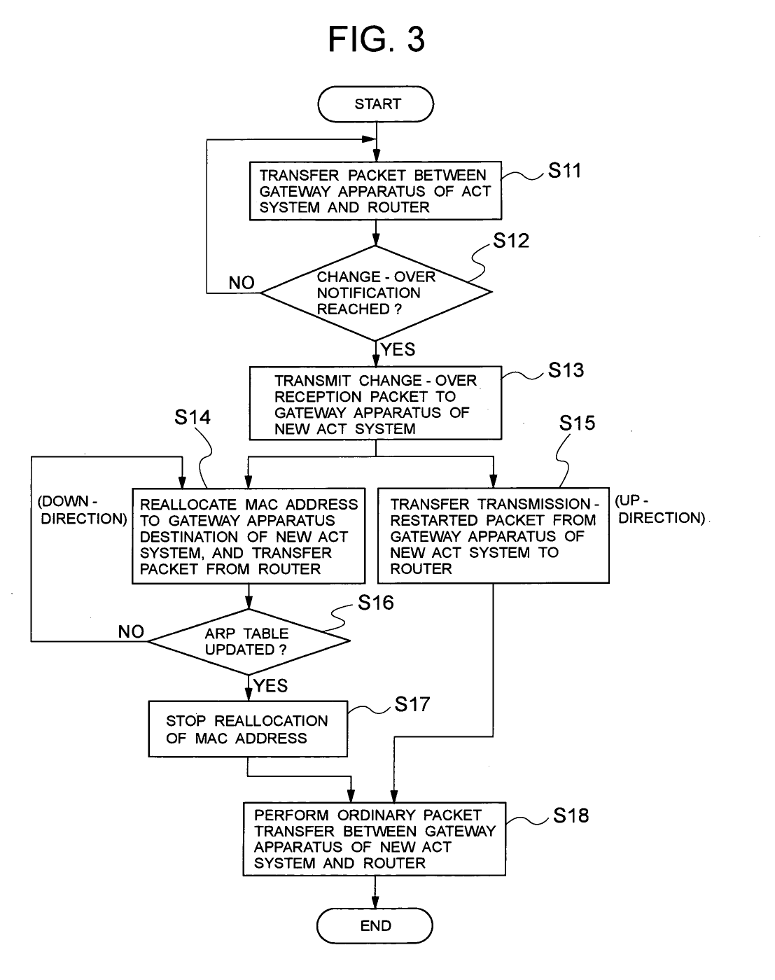

FIG. 3 shows a processing procedure of the LAN switching apparatus at the time of the system changeover. It is assumed as a prerequisite that one of the two gateway apparatuses operates as an ACT system and the other operates as an SBY system. In a manner similar to other node apparatuses such as a router, the MAC address has preliminarily and fixedly set into each of the two gateway apparatuses. The MAC address, therefore, functions as designation information for designating the gateway apparatus.

The LAN switching apparatus 10 stationarily transfers the packet between the gateway apparatus of the ACT system and the router (step S11). After that, it is assumed that a system changeover request has been issued on the redundancy gateway system side. At this time, the redundancy gateway system transmits the changeover request packet toward the LAN switching apparatus 10 and stops the transmission of the packet.

The LAN switching apparatus 10 always discriminates whether or not the changeover notification packet has reached (step S12). If it is decided that the changeover notification packet does not reach yet, the LAN switching apparatus 10 continues the packet transfer between the gateway apparatus of the ACT system and the router. If it is decided that the changeover notification packet has reached, the LAN switching apparatus 10 transmits the changeover reception packet toward the gateway apparatus which has newly become the ACT system (step S13).

For the packet transmitted from the router, the LAN switching apparatus 10 reallocates the MAC address to the gateway apparatus of the new ACT system as a destination and transfers the packet (step S14). That is, since the router is continuously transmitting the packet toward the MAC address of the gateway apparatus of the old ACT system which has been the ACT system hitherto in spite of the system changeover, the LAN switching apparatus 10 executes the process for reallocating to the MAC address of the gateway apparatus of the new ACT system instead of the old ACT system. The packet from the router is, consequently, transmitted to the gateway apparatus of the new ACT system as a destination.

In the redundancy gateway system, the gateway apparatus of the new ACT system restarts the transmission of the packet in accordance with the changeover reception packet in step S13. The LAN switching apparatus 10 transfers the transmitted packet to the router in response to the restart of the transmission of the packet from the gateway apparatus of the new ACT system (step S15).

While executing the transfer accompanied with the reallocation of the MAC address, the LAN switching apparatus 10 always discriminates whether or not the ARP table has been updated (step S16). A determination showing that the ARP table has been updated is made only in the case where the redundancy gateway system side forcedly instructed the updating to each node of the packet network by using the GARP or the case where the destination MAC address of the packet which is transmitted from the router has already been changed to the MAC address of the gateway apparatus of the new ACT system. If it is decided, therefore, that the ARP table is not updated yet, the process for reallocating the MAC address in step S14 is continued. If it is decided that the ARP table has already been updated, the LAN switching apparatus 10 stops the reallocation of the MAC address (step S17) and executes the ordinary packet transfer between the gateway apparatus of the new ACT system and the router (step S18).

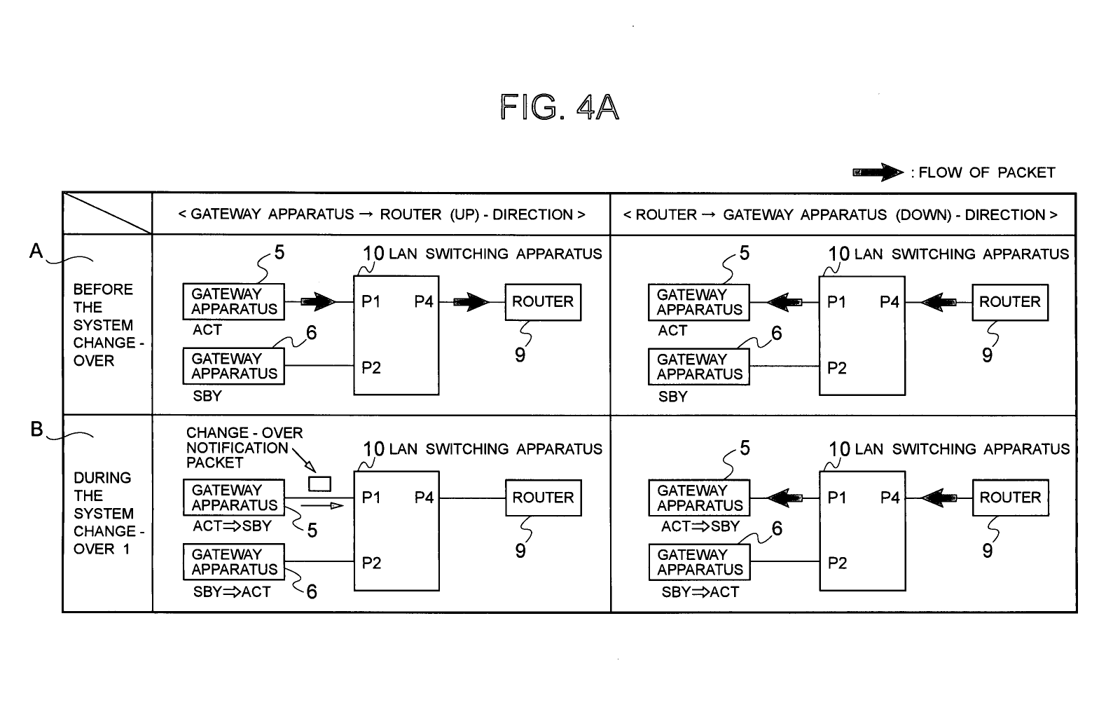

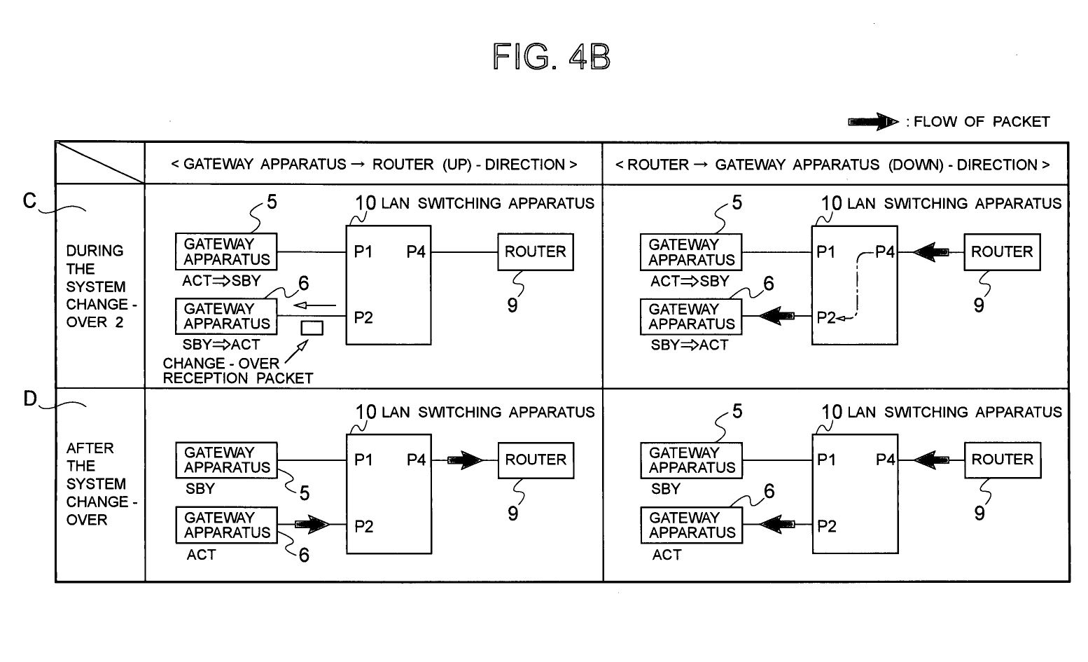

FIGS. 4A and 4B show a flow of the packet at the time of the system changeover in the first embodiment. The router 9 is regarded as an upper apparatus by the gateway apparatuses 5 and 6 and an explanation will be made hereinbelow on the assumption that the direction from the gateway apparatuses 5 and 6 toward the router 9 is referred to as an up-direction and the direction from the router 9 toward the gateway apparatuses 5 and 6 is referred to as a down-direction. The system changeover is performed between the gateway apparatuses 5 and 6 and a processing procedure in the system changeover is divided into four Phases A, B, C, and D and will be described hereinbelow.

“Before the system changeover” of Phase A indicates a stage before the system changeover is started and shows a state where the gateway apparatus 5 is the ACT system and the gateway apparatus 6 is the SBY system. At this time, as for a flow of the packet in the up-direction, the packet is transferred from the gateway apparatus 5 to the port P1 of the LAN switching apparatus 10, passes through the LAN switching apparatus 10, and thereafter, flows to the router 9 through the port P4 of the LAN switching apparatus 10. The packet flows in the down-direction along a path opposite to that in the up-direction.

“system changeover in progress 1” of Phase B indicates a stage where the system changeover is started, the gateway apparatus 5 is shifting from the ACT system to the SBY system, and the gateway apparatus 6 is shifting from the SBY system to the ACT system. At this time, the changeover notification packet is sent to the LAN switching apparatus 10 from the gateway apparatus 5 which is shifted from the ACT system to the SBY system. In this instance, both of the gateway apparatuses 5 and 6 have stopped the transmission of the packet in the up-direction. A flow of the packet in the down-direction is the same as that at Phase A “Before the system changeover”.

“system changeover in progress 2” of Phase C indicates a stage where the LAN switching apparatus 10 has received the changeover notification packet and is transmitting the changeover reception packet to the gateway apparatus 6 as a new ACT system. Also at this point of time, both of the gateway apparatuses 5 and 6 have stopped the transmission of the packet in the up-direction. The router 9 does not stop the transmission of the packet in the down-direction. The destination of the packet in the down-direction is the gateway apparatus 5, that is, the old ACT system. The LAN switching apparatus 10, therefore, reallocates the destination of the packet in the down-direction to the MAC address of the gateway apparatus 6, that is, the new ACT system and transfers the packet through the port P2 to which the gateway apparatus 6 has been connected.

“After the system changeover” of Phase D indicates a stage where the system changeover process of the gateway apparatuses 5 and 6 has been completed, the gateway apparatus 5 has become the SBY system, and the gateway apparatus 6 has become the ACT system. After the changeover reception packet has been received from the LAN switching apparatus 10, the gateway apparatus 6 restarts, as a new ACT system, the transmission of the packet in the up-direction. So long as the packet in the down-direction is transferred with an added MAC address in which the gateway apparatus 5 is set as a destination, the LAN switching apparatus 10 executes the reallocation of the destination MAC address of the packet in the down-direction and transfers the packet to the gateway apparatus 6.

However, since the packet in the up-direction is transmitted from the gateway apparatus 6, the ARP table of the router 9 is rewritten. In accordance with it, the packet in the down-direction is also added with the MAC address in which the gateway apparatus 6 is set to a destination. The reallocation of the MAC address of the packet becomes unnecessary. At this point of time, the LAN switching apparatus 10 stops the reallocation of the MAC address if the packet. In the embodiment, it is assumed that the gateway apparatus 6 which became the new ACT system restarts the transmission of the packet in the up-direction, so that the ARP table of the router 9 is changed. The invention, however, is not limited to the case mentioned above and the ARP table of the router 9 may be forcedly rewritten by transmitting the GARP toward the router 9 by the gateway apparatus 6 before restarting the transmission of the packet.

In the first embodiment mentioned above, since the invention is applied, when executing the system changeover, the reallocation for changing the destination MAC address to the MAC address of the new ACT system is executed by the LAN switching apparatus 10 to the packet in which the old ACT system is set to the destination, so that the packet is transferred to the new ACT system. The timing for the system changeover between the ACT system and the SBY system of the gateway apparatuses and the operation of the LAN switching apparatus, consequently, coincide completely. The packet loss during the system changeover is avoided and the uninterruptible changeover of the gateway apparatuses is realized.

### <Modification of the First Embodiment>

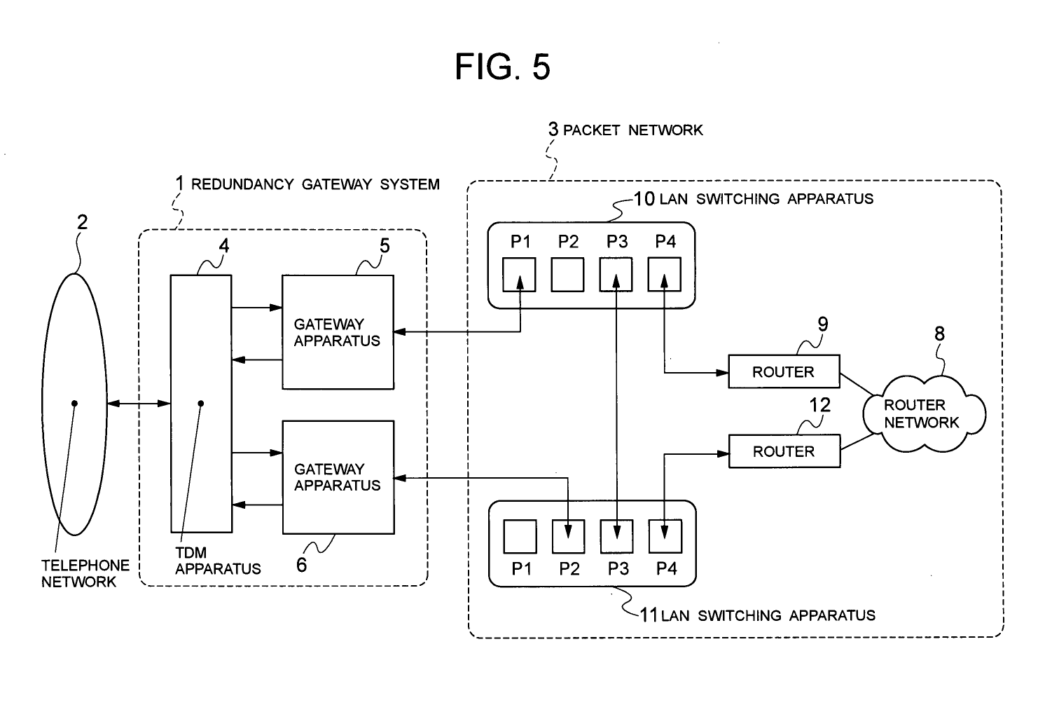

FIG. 5 shows a modification of the first embodiment and shows a whole construction including LAN switching apparatuses according to the invention. In the modification, a LAN switching apparatus and a router are formed as a multiple-redundancy construction and a LAN switching apparatus 11 and a router 12 are added to the construction in the first embodiment. The gateway apparatus 6 is connected to a port P2 of the LAN switching apparatus 11. A port P4 of the LAN switching apparatus 11 is connected to the router 12. The router 12 is connected to the router network 8. A port P3 of the LAN switching apparatus 10 and a port P3 of the LAN switching apparatus 11 are connected. An internal structure of each of the LAN switching apparatuses 10 and 11 is fundamentally similar to that in the first embodiment (refer to FIG. 2).

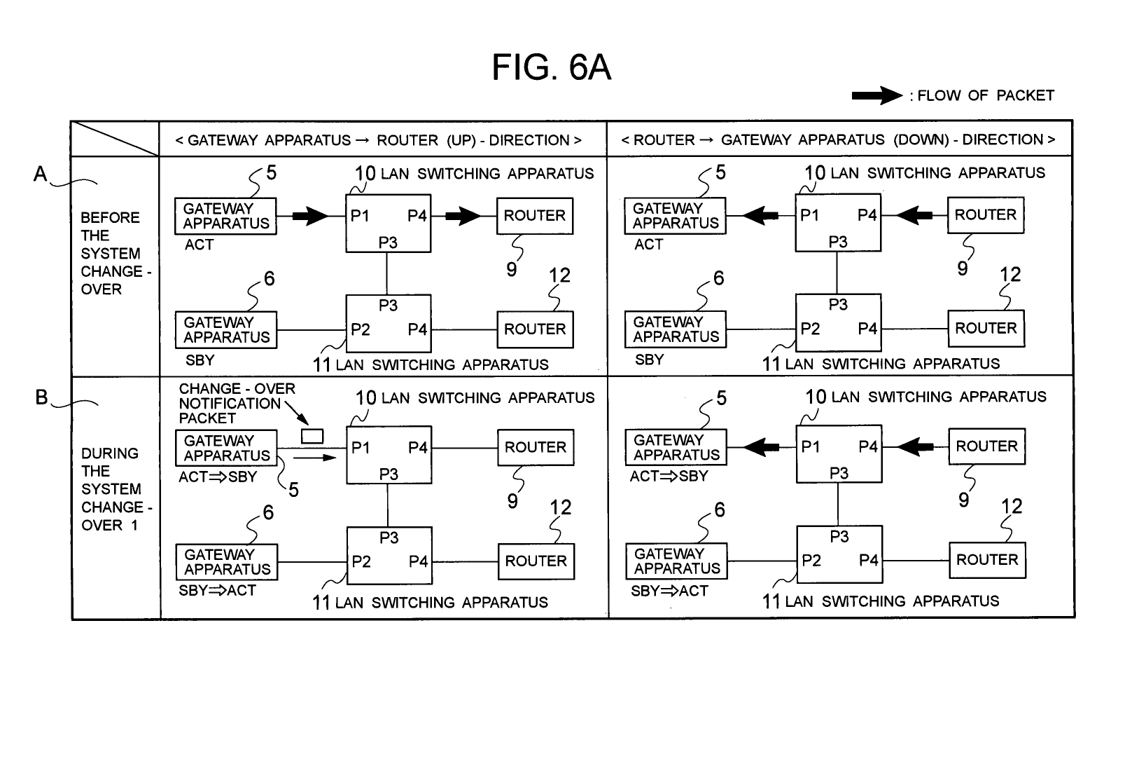

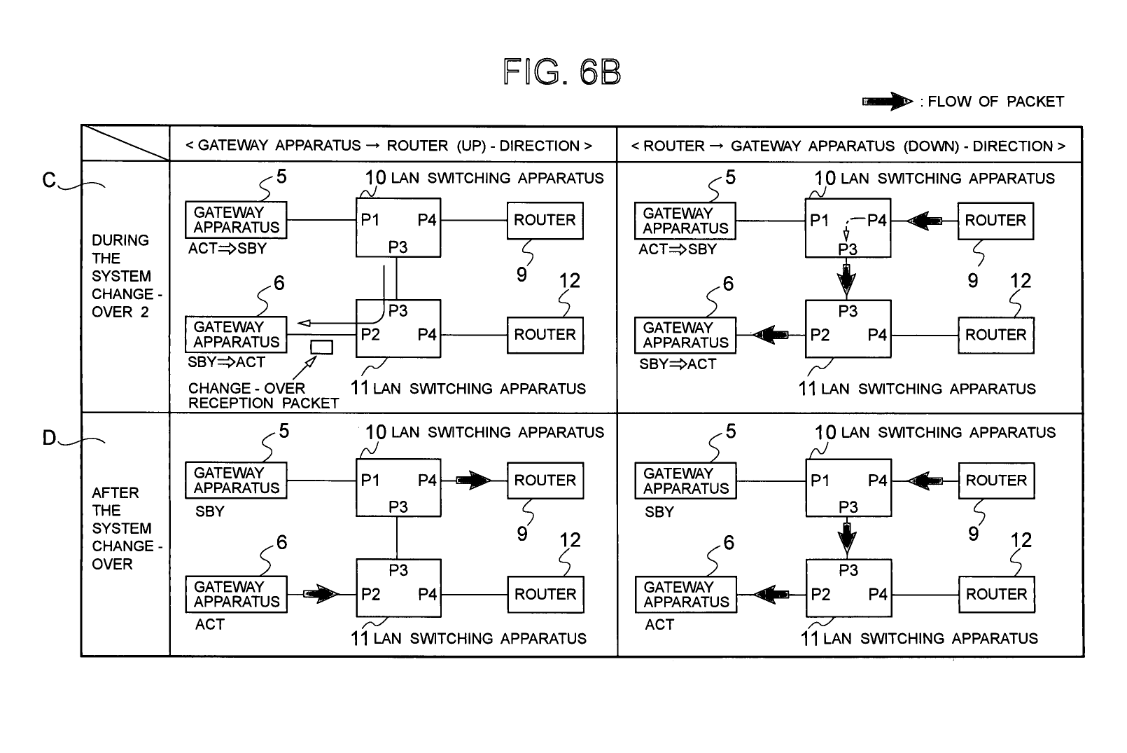

FIGS. 6A and 6B show a flow of the packet in the modification. Although the fundamental operation is similar to that in the first embodiment mentioned above, in correspondence to the duplex of the router and the LAN switching apparatus, the transmitting/receiving operations of the packet and the operation in which in accordance with the arrival of the changeover notification packet in one LAN switching apparatus, the other LAN switching apparatus transmits the changeover reception packet differ between the LAN switching apparatuses 10 and 11.

At Phase C “During the system changeover 2” shown in FIG. 6B, the LAN switching apparatus 10 reallocates the MAC address of the packet in the down-direction in which the old ACT system, that is, the gateway apparatus 5 is set to the destination to the MAC address of the new ACT system, that is, the gateway apparatus 6 and transmits the packet through the port P3. In the LAN switching apparatus 11, the ordinary switching process is executed to the reallocated packet in the down-direction and the packet in the down-direction is sent to the gateway apparatus 6 through the port P2. In each of the gateway apparatuses 5 and 6, registration information such as partner's MAC address and corresponding port P3 has mutually been held in a transfer database.

The changeover reception packet is transferred from the port P3 of the LAN switching apparatus 10 to the LAN switching apparatus 11 through the port P3 of the LAN switching apparatus 11. The ordinary switching process is executed in the LAN switching apparatus 11 and, thereafter, the changeover reception packet is transmitted to the gateway apparatus 6.

In the modification of the first embodiment shown above, by making the LAN switching apparatus and the router redundant, not only usability of the LAN switching apparatus is improved but also the path between the LAN switching apparatus and the router is made redundant and the further improvement of the usability of the LAN switching apparatus itself can be expected. Although the router 12 has been added in FIG. 5, even if it is not added, a network construction can be formed.

### Second Embodiment

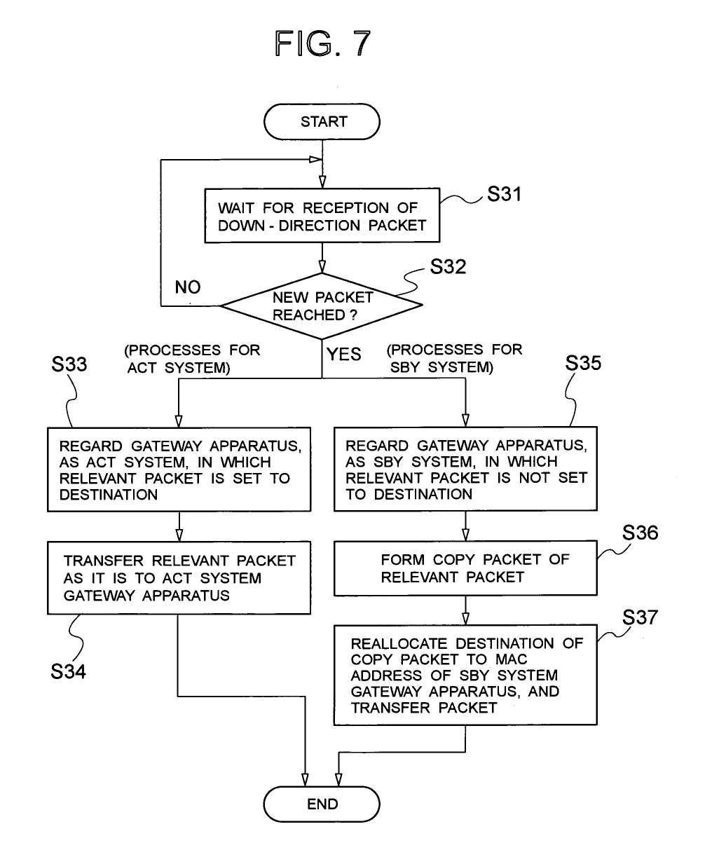

FIG. 7 shows a processing procedure in the direction from the router of the LAN switching apparatus to the gateway apparatus, that is, in the down-direction in the second embodiment. The processing procedure is executed by presuming a construction similar to that in the first embodiment. It is also possible to use a redundancy construction in which the packet is transmitted through a plurality of LAN switching apparatuses in a manner similar to the relation between the first embodiment and its modification. As a prerequisite of the second embodiment, in the redundancy gateway system, it is assumed that one of the two gateway apparatuses operates as an ACT system, the other operates as an SBY system, and only the gateway apparatus of the ACT system transmits the packet in the up-direction. It is also assumed that both of the gateway apparatuses of the ACT system and the SBY system can execute proper packet selecting process and packet abandoning process to the packet having the overlapped contents.

Referring to FIG. 7, stationarily, the LAN switching apparatus 10 waits for the reception of the packet in the down-direction from the router (step S31). Whether or not a new packet has reached is, therefore, discriminated (step S32). If the new packet has reached, a process for the ACT system and a process for the SBY system are executed.

As a process for the ACT system, the LAN switching apparatus 10 regards the gateway apparatus serving as a destination of the relevant packet as an ACT system (step S33). It is based on a presumption that all of the packets in the down-direction which are sent from the router side should be transmitted to the ACT system as a destination. Subsequently, the relevant packet is transferred as it is to the gateway apparatus of the ACT system (step S34).

As a process for the SBY system, the LAN switching apparatus 10 regards the gateway apparatus which does not become the destination of the relevant packet as an SBY system (step S35). It is based on a presumption that the packet in the down-direction which is sent from the router side should be transmitted to the only ACT system as a destination and all of the gateway apparatuses other than the ACT system are the SBY system. Subsequently, the LAN switching apparatus 10 forms a replication packet of the relevant packet (step S36), reallocates the destination of the formed replication packet to the MAC address of the gateway apparatus of the SBY system, and transfers the packet to the SBY system gateway apparatus (step S37).

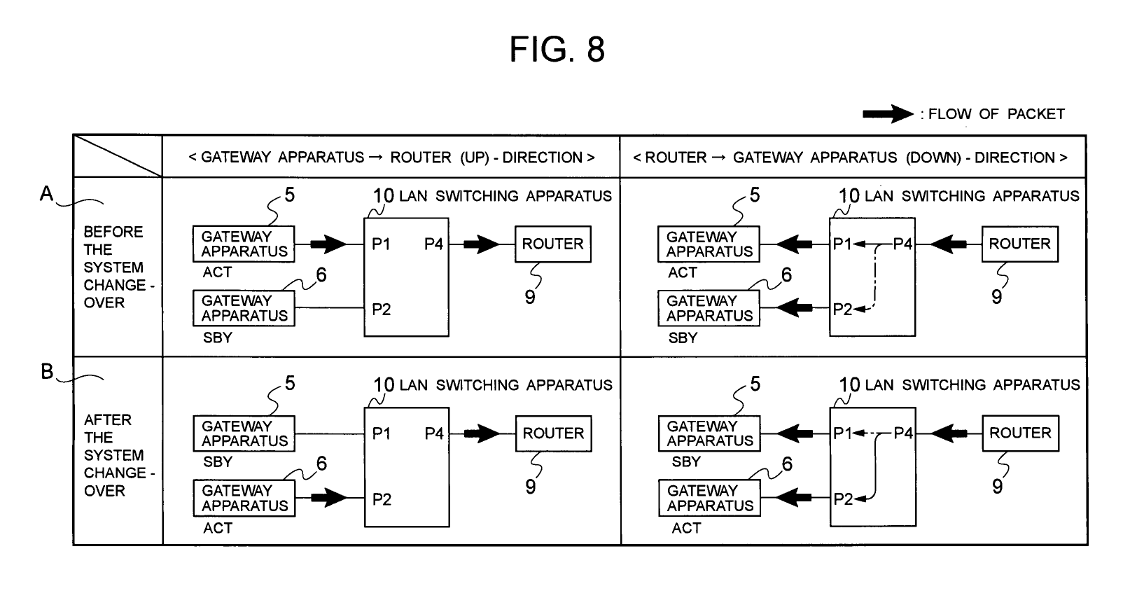

FIG. 8 shows a flow of the packet in the second embodiment. Since only the gateway apparatus of the ACT system transmits the up-direction packet as a prerequisite, if the system changeover occurred, the MAC address of the transmitting source of the packet in the up-direction becomes the MAC address of the gateway apparatus 6 as a new ACT system. Since the up-direction packet is transferred, the ARP table of each node such as a router is rewritten. The destination MAC address of the packet in the down-direction, consequently, suddenly changes from the previous MAC address of the gateway apparatus 5 to the MAC address of the gateway apparatus 6.

At Phase A “Before the system changeover” shown in FIG. 8, the LAN switching apparatus 10 receives the down-direction packet in which the MAC address of the gateway apparatus 5 of the ACT system is set to the destination MAC address and transfers it to the gateway apparatus 5 through the port P1. In parallel with it, a replication packet of the relevant packet is formed and its destination MAC address is reallocated to the MAC address of the gateway apparatus 6 as an SBY system, thereby transmitting the packet to the gateway apparatus 6 through the port P2.

At Phase B “After the system changeover” shown in FIG. 8, the destination MAC address of the packet in the down-direction suddenly changes from the previous MAC address of the gateway apparatus 5 to the MAC address of the gateway apparatus 6. The LAN switching apparatus 10, therefore, transfers the relevant down-direction packet through the port P2 to the gateway apparatus 6 which has become a new ACT system. In parallel with it, a replication packet of the relevant packet is formed and its destination MAC address is reallocated to the MAC address of the gateway apparatus 5 as an old ACT system, thereby transmitting the packet to the gateway apparatus 5 through the port P1.

In the foregoing second embodiment, since the LAN switching apparatus 10 always transfers the packet to both of the ACT and SBY systems without being conscious of the system changeover timing, the processes regarding the changeover notification packet and the changeover reception packet shown in the first embodiment and its modification become unnecessary. Since the packet is always copied and transferred to a plurality of gateway apparatuses, it is seen from the gateway apparatus as if the packet network itself were duplexed. It is, therefore, unnecessary to exchange the packet received between the redundant gateway apparatuses through a confounding line and the packet can be used in common between the gateway apparatuses. By storing the same audio data, consequently, into a jitter buffer in each gateway apparatus, a fluctuation absorption of the packet network can be made operative in the same state, an audio processing state of an echo canceller or the like can be made operative in the same state, and a voice interruption or the like at the time of the system changeover can be reduced as far as possible.

In the second embodiment, a different technique is employed although it is presupposed to employ a port mirroring technique in the prior art with respect to the duplication of the packet. In such a port mirroring technique, the reallocation of the MAC address is not performed and exactly the same packet is duplicated. In this regard, as for the duplication of the packet in the embodiments, the MAC address is changed and the packet is copied. It should be noted that it differs from the port mirroring technique in the prior art.

Although the configuration in which the number of transfer destinations to which the packet is transferred from the LAN switching apparatus is limited to 1 has been shown in the plurality of embodiments mentioned above, the invention can be also applied to a form in which there are a plurality of transfer destinations. Although the configuration in which the destination MAC address of the packet is reallocated according to the MAC address which has previously been registered has been shown, in place of such a configuration, it is also possible to adopt a configuration in which by embedding information of the destination MAC address into a part of the format of the changeover notification packet, the MAC address of the packet is reallocated based on the embedded destination MAC address. In the configuration in which the changeover notification packet is unnecessary as mentioned in the second embodiment, it is possible to attain the objective by transmitting the packet from the gateway apparatus side to the LAN switching apparatus while allowing the information of the destination MAC address to be included in the packet corresponding to the changeover notification packet. According to this configuration, the reallocation information of the MAC address can be dynamically set and it is possible to flexibly cope with a change in network environment.

This application is based on Japanese Patent Application No. 2007-212858 which is hereby incorporated by reference.

What is claimed is:

1. A network switching apparatus provided between a packet network and a plurality of gateway apparatuses at least one of which is provided as a gateway apparatus of an active system, said apparatus comprising:
an up-direction transfer unit which transfers an up-direction packet which is transmitted by said active system gateway apparatus to said packet network; and
a down-direction transfer unit which transfers a down-direction packet which is accompanied with designation information of said active system gateway apparatus and transmitted by said packet network in accordance with said up-direction packet to said active system gateway apparatus,
wherein said down-direction transfer unit includes:
a changeover notification packet receiving component which receives a changeover notification packet accompanied with designation information of a new active system gateway apparatus which has newly been set in place of said active system gateway apparatus; and
a switching-time transfer component which changes said designation information to the designation information of said new active system gateway apparatus, thereby transferring said down-direction packet to said new active system gateway apparatus, only in the case where a down-direction packet which is newly transmitted by said packet network after the reception of said changeover notification packet is accompanied with the designation information of the active system gateway apparatus before the changeover.

2. An apparatus according to claim 1, wherein said switching-time transfer component changes a destination address included in said down-direction packet as said designation information.

3. A network switching apparatus which is provided between a packet network and a plurality of gateway apparatuses at least one of which is provided as a gateway apparatus of an active system, said apparatus comprising:
an up-direction transfer unit which transfers an up-direction packet which is transmitted by said active system gateway apparatus to said packet network; and
a down-direction transfer unit which transfers a down-direction packet which is accompanied with designation information of said active system gateway apparatus and transmitted by said packet network in accordance with said up-direction packet to said active system gateway apparatus,
wherein said down-direction transfer unit includes:
a standby system gateway apparatus discriminating component which discriminates the gateway apparatus, as a standby system gateway apparatus, other than the active system gateway apparatus corresponding to the designation information accompanied by said down-direction packet every down-direction packet which is newly transmitted by said packet network; and
a replication packet transfer component which forms a replication packet of said down-direction packet every said discriminated standby system gateway apparatus and changes designation information accompanied by said replication packet to designation information of said standby system gateway apparatus, thereby transferring said replication packet to said standby system gateway apparatus.

4. A network switching apparatus provided between a packet network and a plurality of gateway apparatuses at least one of which is provided as a gateway apparatus of an active system, said apparatus comprising:
an up-direction transfer unit for transferring an up-direction packet which is transmitted by said active system gateway apparatus to said packet network; and
a down-direction transfer unit for transferring a down-direction packet which is accompanied with designation information of said active system gateway apparatus and transmitted by said packet network in accordance with said up-direction packet to said active system gateway apparatus,
wherein said down-direction transfer unit includes:
changeover notification packet receiving means for receiving a changeover notification packet accompanied with designation information of a new active system gateway apparatus which has newly been set in place of said active system gateway apparatus; and
switching-time transfer means for changing said designation information to the designation information of said new active system gateway apparatus, thereby transferring said down-direction packet to said new active system gateway apparatus, only in the case where a down-direction packet which is newly transmitted by said packet network after the reception of said changeover notification packet is accompanied with the designation information of the active system gateway apparatus before the changeover.

5. An apparatus according to claim 4, wherein said switching-time transfer means changes a destination address included in said down-direction packet as said designation information.

6. A network switching apparatus which is provided between a packet network and a plurality of gateway apparatuses at least one of which is provided as a gateway apparatus of an active system, said apparatus comprising:
an up-direction transfer unit which transfers an up-direction packet which is transmitted by said active system gateway apparatus to said packet network; and
a down-direction transfer unit which transfers a down-direction packet which is accompanied with designation information of said active system gateway apparatus and transmitted by said packet network in accordance with said up-direction packet to said active system gateway apparatus,
wherein said down-direction transfer unit includes:
standby system gateway apparatus discriminating means for discriminating the gateway apparatus, as a standby system gateway apparatus, other than the active system gateway apparatus corresponding to the designation information accompanied by said down-direction packet every down-direction packet which is newly transmitted by said packet network; and
replication packet transfer means for forming a replication packet of said down-direction packet every said discriminated standby system gateway apparatus and changing designation information accompanied by said replication packet to designation information of said standby system gateway apparatus, thereby transferring said replication packet to said standby system gateway apparatus.
